(19) United States
(12) Patent Application Publication
(10) Pub. No.: US 2017/0228621 A1
(43) Pub. Date: Aug. 10, 2017

(54) IMAGE FORMING METHOD, IMAGE FORMING SYSTEM AND IMAGE FORMING APPARATUS

(71) Applicant: Oki Data Corporation, Tokyo (JP)

(72) Inventors: Miwako ISHII, Tokyo (JP); Katsuyoshi YAMANOUCHI, Tokyo (JP)

(21) Appl. No.: 15/498,118

(22) Filed: Apr. 26, 2017

Related U.S. Application Data
(62) Division of application No. 14/741,023, filed on Jun. 16, 2015.

(30) Foreign Application Priority Data
Jun. 18, 2014 (JP) 2014-125562

(51) Int. Cl. G06K 15/02; G06F 3/12

(52) U.S. Cl. CPC G06K 15/1878; G06K 15/1809; G06F 3/1205; G06F 3/1243; G06F 3/1254; G06F 3/1285; G06F 3/1248

(57) ABSTRACT

An image forming method using plural types of developers includes: step for performing a designation relating to a change of a type of developer to be used; step for inputting first image data including a first image of a first color that is different from the type of developer designated by the change of the type; step for receiving second image data including a second image of the first color that is designated; step of changing at least the first color of the first image data to a developer designated by the change of the type; and step for printing the first image data of which the first color is changed and the second image data expressing the first color without changing the first color on a same medium.

### CROSS REFERENCE

The present application is a divisional of U.S. patent application Ser. No. 14/741,023, filed on Jun. 16, 2015, and is related to, claims priority from and incorporates by reference Japanese Patent Application No. 2014-125562, filed on Jun. 18, 2014.

### TECHNICAL FIELD

The present invention relates to an image forming method, an image forming system, and an image forming apparatus for performing a special color printing by a special color developer.

### BACKGROUND

In a conventional image forming method, an image is formed using a special color developer, such as white or transparent, in a region where an object is arranged (see, e.g., Patent Document 1). Herein, the object means a drawing to be printed but that is not included in a print target document. Watermark is an example of the object. [Patent Document 1] Japanese Unexamined Patent Application Publication No. 2014-23037

However, in a conventional technology, when operating to perform the printing for an object, there are problems that the printing could not be performed by designating the object and a special color developer, and that a specific application (computer program) is required to perform such a printing. The present invention aims to solve such problems and enable printing in which a drawing by a special color developer can be specified.

An image forming method, which is disclosed in the application, using plural types of developers includes: step for performing a designation relating to a change of a type of developer to be used; step for inputting first image data including a first image of a first color that is different from the type of developer designated by the change of the type; step for receiving second image data including a second image of the first color that is designated; step of changing at least the first color of the first image data to a developer designated by the change of the type; and step for printing the first image data of which the first color is changed and the second image data expressing the first color without changing the first color on a same medium.

According to the present invention, a printing of an object with a special color developer can be performed without a special application.

### BRIEF EXPLANATIONS OF DRAWINGS

FIG. 1 is a block diagram showing a structure of an image forming system according to a first embodiment.

FIG. 2 is a schematic side cross-sectional view showing a structure of an image forming apparatus according to the first embodiment.

FIGS. 3A and 3B are an explanatory view of a setting screen and print data of the first embodiment.

FIGS. 4A-4C are an explanatory view of a setting screen for a special color designation and print data of the first embodiment.

FIG. 5 is a flowchart showing a flow of print processing of the first embodiment.

FIG. 6 is an explanatory view of a generation of a print image and a print result according to the first embodiment.

FIG. 7 is an explanatory view of a generation of a print image and a print result according to the first embodiment.

FIGS. 8A and 8B are an explanatory view of a setting screen for printing a form with a special color designation and print data according to the first embodiment.

FIG. 9 is a block diagram showing a structure of an image forming system according to a second embodiment.

FIG. 10 is a schematic side cross-sectional view showing a structure of an image forming apparatus according to the second embodiment.

FIG. 11 is a flowchart showing a flow of print data creation processing according to the second embodiment.

FIG. 12 is a flowchart showing a flow of print processing according to the second embodiment.

FIG. 13 is a flowchart showing a flow of normal data edit processing according to the second embodiment.

FIG. 14 is a flowchart showing a flow of form data edit processing according to the second embodiment.

FIGS. 15A-15C are an explanatory view of form data, normal data, and a print result according to the second embodiment.

FIGS. 16A-16C are an explanatory drawing of form data, normal data, and print result according to the second embodiment.

### DETAILED DESCRIPTIONS OF PREFERRED EMBODIMENTS

Hereinafter, with reference to the drawings, embodiments of an image forming method, an image forming system, and an image forming apparatus according to the present invention will be explained.

### Embodiment 1

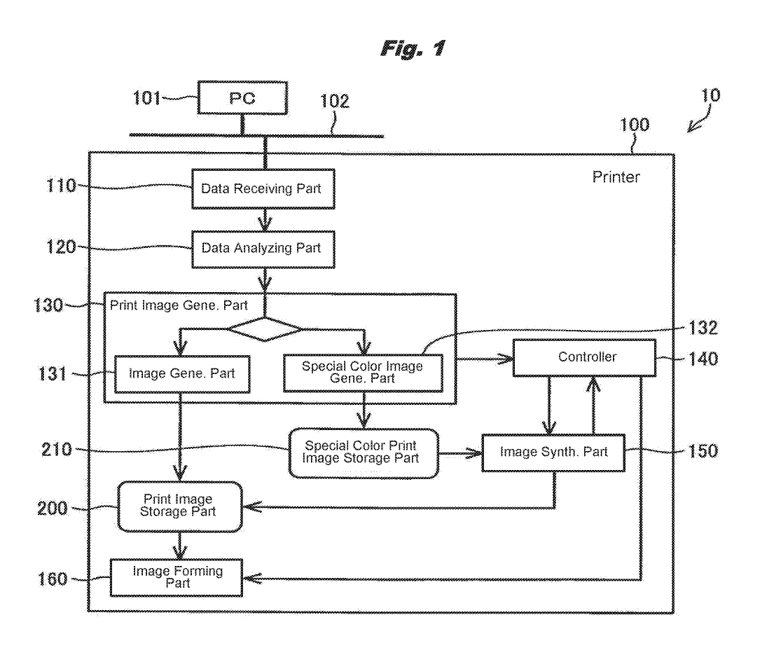

FIG. 1 is a block diagram showing a structure of an image forming system according to a first embodiment.

In FIG. 1, the image forming system 10 is for forming an image using plural types of developers, and is constituted by a printer 100 as an image forming apparatus, a PC (personal computer) 101 as a higher-level device, and a communication line 102 for connecting the printer 100 and the PC 101 in a communicable manner. The printer 100 includes known components such as a processor, a memory part and a communication device. With the processor, functions for forming the image using the plural types of developers are performed. With the memory part, programs are stored to be executed by the processor for forming the image. With the communication device, the communication between the PC 101 and an outside device via the communication line 102 is allowed.

In the PC 101, a printer driver (software) as a print data generation device is installed, and the PC 101 transmits print data to the printer 100. The print data includes a PDL (Page Description Language) as print setting information and drawing data in which a document as a print target can be analyzed by a later explained data analyzing part 120 of the printer 100, and a special color designation/cancellation command (command) for instructing the setting and the cancellation of a special color mode for performing special color printing by a special color toner of, e.g., a white color, transparent, etc.

Further, the printer driver of the PC 101 as a designation part receives the designation relating to a change of a type of a developer to be used.

The printer 100, based on print data generated by the printer driver, forms an image by a developer (color toner) of a cyan color, a magenta color, a yellow color, a black color, a red color, a green color, a blue color, etc., and a special developer (special color toner) of a white color, transparent, a gold color, a silver color, paste, adhesive agent, etc.

The printer 100 includes a data receiving part 110, a data analyzing part 120, a print image generation part 130, a controller 140, an image synthesizing part 150, an image forming part 160, a print image storage part 200, and a special color print image storage part 210.

The data receiving part 110 as a receive (input) part receives print data sent from the PC 101 via a communication line 102 and forwards it to the data analyzing part 120.

The data analyzing part 120 analyzes the print data received from the data receiving part 110 and transfers a notification of a special color designation/cancellation and PDL data to the print image generation part 130.

The print image generation part 130 as an image generation part includes an image generation part 131 for generating print image data for printing on a medium according to the PDL data included in the print data and storing it in a print image storage part 200, and a special color image generation part 132 for making the color of a drawing object of the PDL data monochrome by grayscale conversion to generate image data for special color printing and storing it in a special color printing image storage part 210. In accordance with the notification of the special color designation/cancellation transferred from the data analyzing part 120, the print image generation part 130 switches the image generation part 131 and the special color image generation part 132. The print image generation part 130, after completion of processing of the PDL data for one page, notifies the controller 140 that the print image data is generated. The print data means output data from a driver. The print image data means data of an image that are configured with bitmap to be sent to the printer engine (or head).

The controller 140 receives a notification that print image data is created from the print image generation part 130, then instructs an image synthesizing part 150 to synthesize special color image data and image data not including a special color, and after completion of the synthesizing of the image data, the controller 140 instructs an image forming part 160 to perform printing.

The image synthesizing part 150, when special color image data exists in a special color print image storage part 210, adds the special image data to image data stored in a print image storage part 200 and synthesizes them.

The image forming part 160 as a print part reads print image data from the print image storage part 200 according to the instruction of the controller 140, then transfers and fuses toner image based on the read print image data to a medium such as a print sheet to execute printing.

The print image storage part 200 is a memory part for storing print image data generated by the print image generation part 130 and the print image data synthesized by the image synthesizing part 150.

The special color print image storage part 210 is a memory part for storing image data for special color printing generated by the special color image generation part 132.

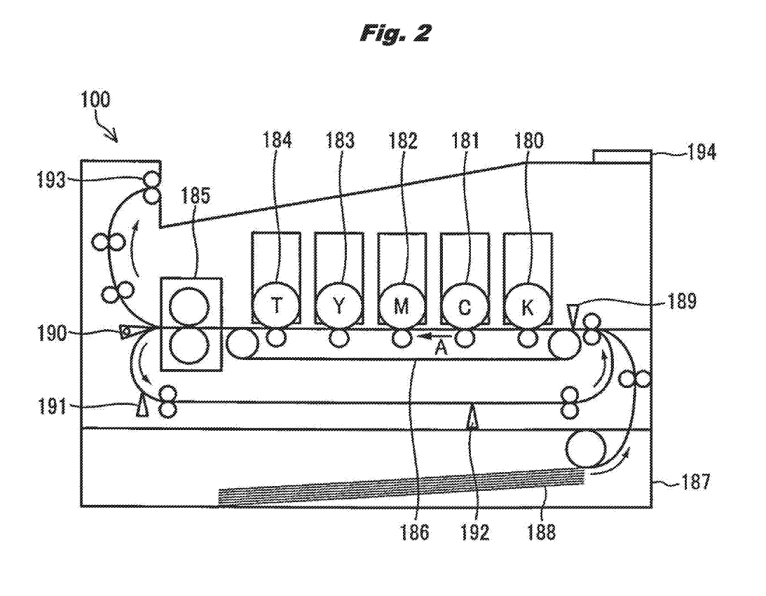

FIG. 2 is a schematic side view showing a structure of an image forming apparatus of the first embodiment.

In FIG. 2, the printer 100 is constituted by a panel section 194, image drums 180, 181, 182, 183, and 184 for forming and transferring a toner image as a developer image of each color of KCMYT (K: black, C: cyan, M: magenta, Y: yellow, T: special color) on a medium, a fuser 185 for fusing the toner transferred on a medium with heat, a carrying belt 186 for carrying the medium in the medium carrying direction shown by the arrow A in the drawing, a tray unit 187 for storing a medium 188, and a selector switch 190 for selecting either ejecting the medium in which the toner was fused to an outside of the apparatus via an ejection roller 193 or carrying it again to the image drums 180, 181, 182, 183, and 184 via sensors 191, 192, and 189.

In this embodiment, the image drums are arranged in the order of an image drum (K) 180, an image drum (C) 181, an image drum (M) 182, an image drum (Y) 183, and an image drum (T) 184 from the upstream side of the carrying direction of the medium.

The image forming part 160 shown in FIG. 1 controls each of the aforementioned structures to transfer and fuse the toner image formed based on the print image data to the medium to thereby perform printing on the medium.

In the printer 100 structured as explained above, it is configured such that image can be formed by being transferred and fused on the same medium separately in a plurality of times.

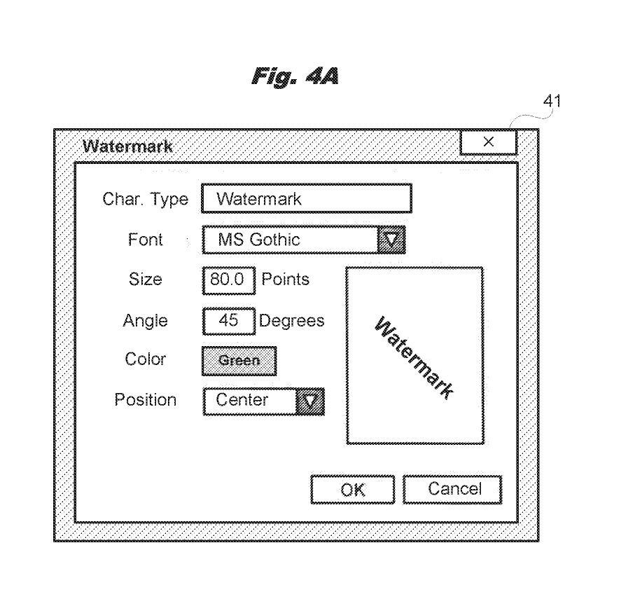

FIG. 4 shows explanatory views of setting screens and print data for a special color designation according to the first embodiment.

FIG. 4A shows a watermark setting screen of a printer driver installed in the PC 101 shown in FIG. 1, FIG. 4B shows a setting screen of the printer driver for designating a content of special color printing, and FIG. 4C shows print data generated by the printer driver.

The watermark setting screen 41 shown in FIG. 4A is a screen for performing a designation relating to a change of a type of a developer to be used.

In this watermark setting screen 41, by performing a setting of adding a watermark to a print target document, it is possible to perform printing in a manner as to put the watermark on the print target document by designating any character type.

On the setting screen 42 for designating the content of the special color printing shown in FIG. 4B, it is possible to specify to print a watermark with a special color by the checkbox 421. In this way, in this embodiment, it is possible for the printer driver to designate a special color for additional print data (for example, watermark) other than print data of the print target document.

The print data 43 shown in FIG. 4C is print data that the printer driver generates according to the content set on the setting screens shown in FIGS. 4A and 4B, and, for example, is constituted by print data 43a generated by one page of the print target document, a special color designation command 43b, print data 43c that the printer driver generates for drawing a watermark (green as the first color), and a special color designation cancellation command 43d.

The print data 43c is first image data (image data to be printed with a special color developer, hereinafter referred to as “special color image data”) corresponded to the printer 100 on the setting screen 42, including first image of a first color (a color including at least one color among colors of cyan, magenta, yellow, black, red, green, and blue) that is different from the type (special color developer) of the developer that is designated by the type change.

Further, the print data 43a is second image data (image data printed with a color developer, hereinafter referred to as “normal image data”) corresponded to the printer 100 on the setting screen 42, including a second image of the first color (a color including at least one color among colors cyan, magenta, yellow, black, red, green, and blue) that is different from the type (special color developer) of the developer that is designated by the type change.

The functions of the aforementioned structure will be explained.

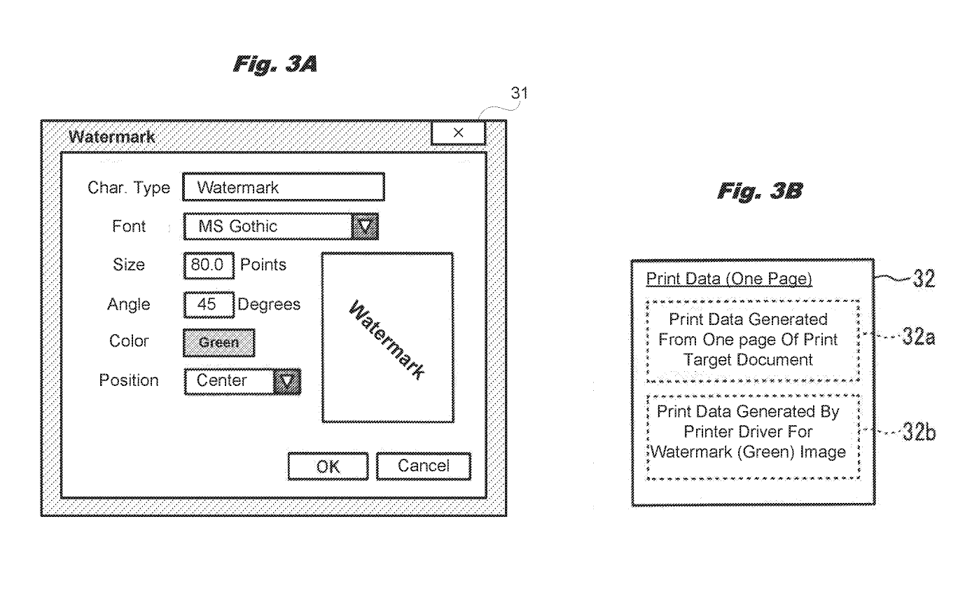

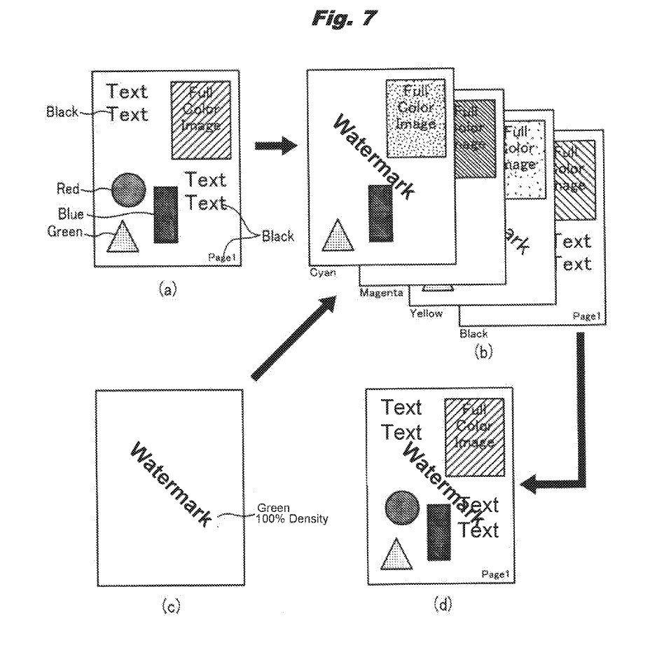

First, the setting screen of the printer driver operating on the PC 101 shown in FIG. 1 will be explained based on FIG. 3, FIG. 4 and FIG. 8.

In FIG. 3A, the setting screen 31 is a screen for performing print setting of a watermark, and when performing document printing, it is a screen for performing a setting for adding a drawing (for example, watermark) not included in a document to print data to be printed.

According to the information set on the setting screen 31, as shown in FIG. 3B, the printer driver generates print data 32 in which print data 32b that the printer driver generates for a watermark (green) drawing is added to print data 32a generated by one page of a print target document.

When printing the watermark which was set for printing with a special color on the setting screen 31, on the setting screen 42 shown in the aforementioned FIG. 4B, it is designated to print the watermark with the special color. In the embodiment, green is set as an initial setting of the watermark. The color of the initial setting is selected among normal colors.

The printer driver, as shown in FIG. 4C, adds a special color designation command 43b before the print data 43c that the printer driver generates for drawing a watermark (green), and adds a special color designation cancellation command 43d after the print data 43c. In addition, the print data 43c that the printer driver generates for drawing the watermark (green) is print data of the same color (for example, green) as in the case in which a special color printing designation is not performed.

Further, FIG. 8 shows explanatory drawings of a setting screen and print data for printing a form with a special color designation according to the first embodiment, and it is also possible to print the form data with a special color.

In FIG. 8A, the setting screen 81 is a screen in a case in which form data registered in the printer 100 shown in FIG. 1 is printed with a special color. By selecting the checkbox 811 on the setting screen 81 and inputting a form ID number (for example, “1”), it is possible to designate that printing of a form designated by a special color.

The printer driver, as shown in FIG. 8B, adds a special color designation command 82a before a command 82b for executing the form data having an ID No. 1 registered in the printer and a special color designation cancellation command 82c is added after the command 82b. Further, the form data itself registered in the printer is color or a grayscale print data that does not include a special color designation, and the print data 82d generated by one page of the print target document is print data that does not include the special color designation.

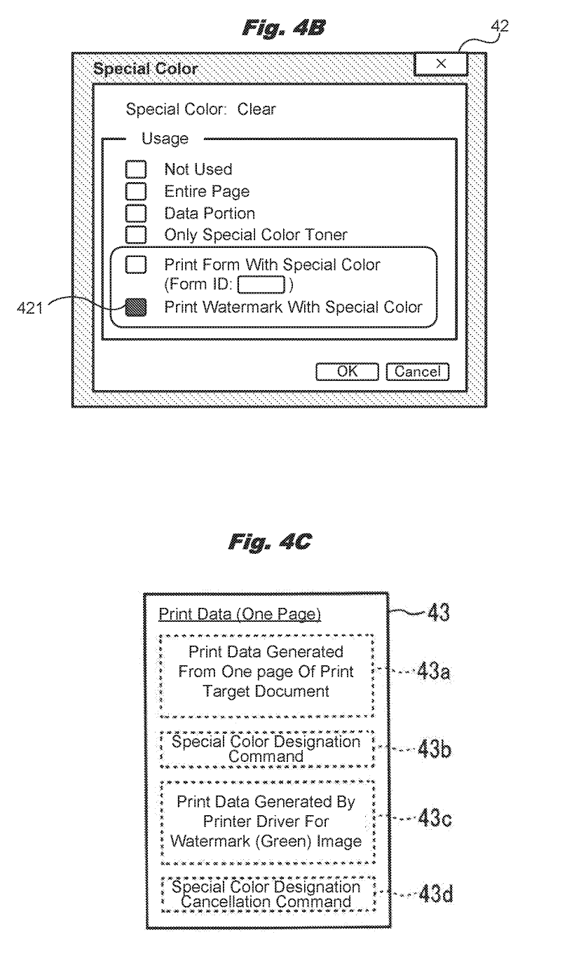

Next, print processing of a printer for printing print data generated in a case in which it is designated to print a watermark with a special color on the setting screen 42 shown in FIG. 4 will be explained with reference to FIG. 1 according to the steps expressed as S, shown in the drawings of the flowchart showing the flow of the print processing in the first embodiment of FIG. 5.

First, the printer driver of the PC 101, on the setting screens 41 and 42 shown in FIGS. 4 A and B, as a step for performing a designation relating to a change of a type of a developer to be used, it is designated that a watermark is printed with a special color and when printing is executed, print data 43 as shown in FIG. 4C is generated and sent to the printer 100 via the communication line 102.

S1: The data receiving part 110 of the printer 100 receives (inputs) print data (for example, print data 43 shown in FIG. 4C) sent from the PC 101 via the communication line 102 and forwards it to the data analyzing part 120.

S2: The data analyzing part 120 analyzes the print data received from the data receiving part 110, judges whether or not it is a special color designation or cancellation, and after determining that it is drawing (PDL) data that is not for special color designation or cancellation, to generate a print image, the PDL data is transferred to the print image generation part 130 to shift the process to S5. When determined that it is a special color designation or cancellation, it is further determined whether it is a special color designation or a special color designation cancellation, and when it is determined to be a special color designation (determined that a designation for performing a change of the type of developer to be used is performed), the print image generation part 130 is notified of a special color designation and the process proceeds to S3. When it is determined to be a special color designation cancellation (determined that a designation for not performing a change of the type of a developer to be used is performed), the print image generation part 130 is notified of a special color designation cancellation and the process proceeds to S4.

S3: The print image generation part 130 that received the notification of a special color designation, sets the status to a special color mode status, switches the setting so that the print data is processed by the special color image generation part 132 until a special color designation cancellation is received, and shifts the process to S9.

S4: The print image generation part 130 that received the notification of a special color designation cancellation cancels the special color mode, switches the setting so that the print data is processed by the special color image generation part 131 until a special color designation is received, and shifts the process to S9.

S5: The print image generation part 130 that receives the PDL data determines whether or not it is in a special color mode, and when it is determined that it is in a special color mode, the process proceeds to S6, and when it is determined that it is not in a special color mode, the process proceeds to S8.

S6: The special color image generation part 132 of the print image generation part 130, which determined to be the special color mode, makes the color of the drawing object of the PDL data of the print data monochrome by grayscale conversion.

S7: The special color image generation part 132 generates special color print image data from the PDL data of the monochrome print data, stores it in the special color print image storage part 210, and shifts the process to S9. In this way, the special color image generation part 132 changes at least the first color of the special color designated print data (special color image data) to a special color developer (developer designated by the type change).

S8: On the other hand, in S5, the image generation part 131 of the print image generation part 130 which was determined not to be in a special color mode generates print image data of a color not including a special color according to the PDL data of the print data and stores it in the print image storage part 200.

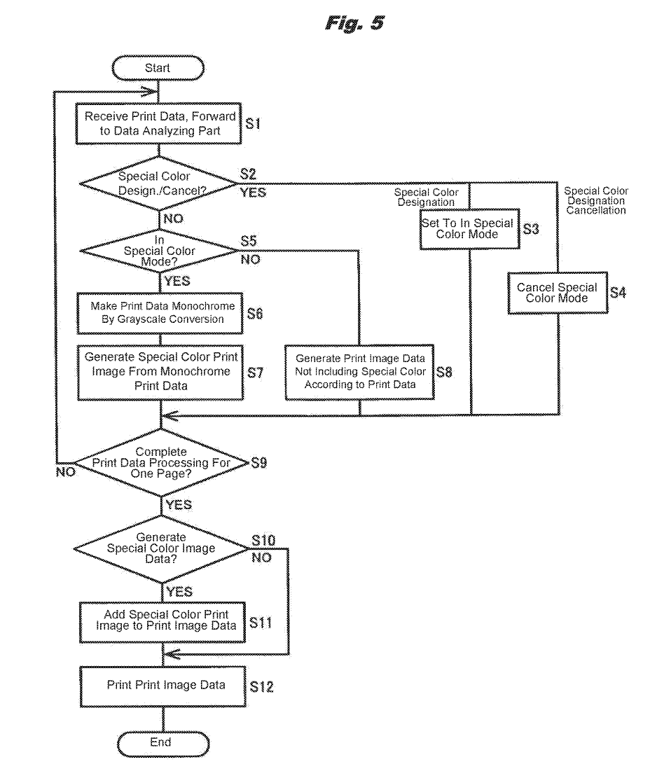

For example, print data generated from a print target document as shown in FIG. 6A that is not designated for a special color (for example, print data 43a as shown in FIG. 4C) is generated as image data for printing CMYK (cyan, magenta, yellow, black) as shown in FIG. 6B in the image generation process of S8.

On the other hand, print data generated like the watermark as shown in FIG. 6C and designated for a special color (for example, print data 43c as shown in FIG. 4C) is grayscale converted in S6. Since the color of the watermark as shown in FIG. 6C was green (green:100%), the result of the grayscale conversion is gray of about 41% density, and it is generated as a special color image data for printing as a special color of 41% density as shown in FIG. 6D in S7. The above “41% density” of grayscale conversion is an initial setting that is registered in advance. The initial setting of grayscale conversion can vary in accordance with the initial normal color. In the embodiment, the green watermark is converted in a monochrome manner into 41% density. In a case where the watermark is red, it may be converted into 78% density. That is because when the watermark is red with 100% density (255, 0, 0), the density that is after monotone conversion becomes thicker (or higher) than that of green with 100% density (0, 255, 0), causing the density of clear toner thicker. It is also possible to set several densities according to types of watermarks. For example, a density may be 41% when the type of watermark is SAMPLE. Another density may be 68% when the type of watermark is CONFIDENTIAL.

S9: The print image generation part 130 determines whether or not the processing of one page of print data is completed, and if it is determined that it is completed, the process proceeds to S10, and if it is determined that it is not completed, the process proceeds to S1 to continue the process of the data analysis and the image generation.

S10: The print image generation part 130 which determined that the print data processing for one page was completed notifies the controller 140 that the generation of the print image was completed. The controller 140 that received the notification that the generation of the print image was completed instructs the image synthesizing part 150 to synthesize the print image data not including a special color and special color image data.

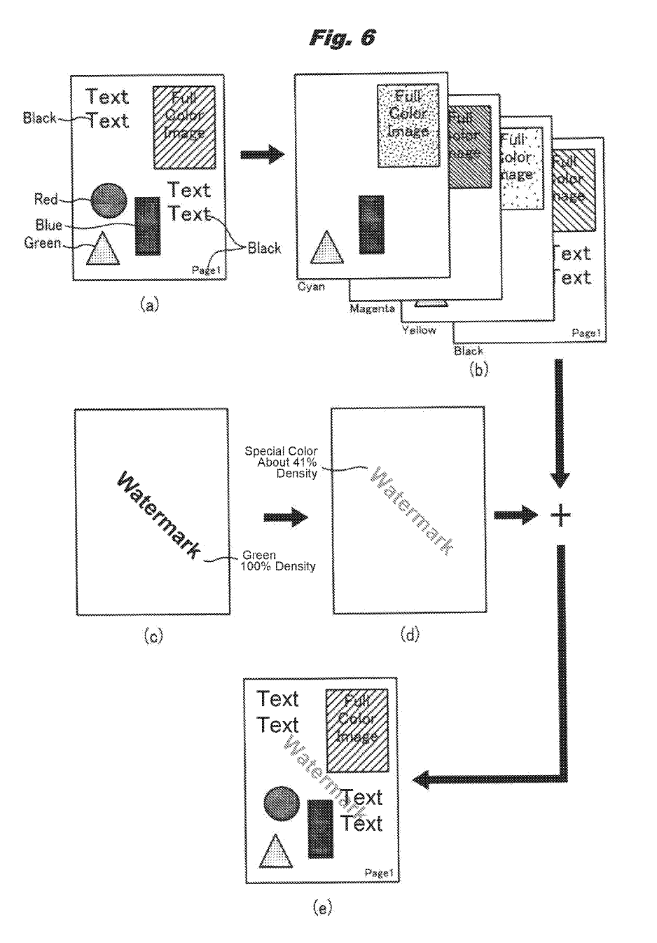

The image synthesizing part 150 determines whether or not special color image data was generated, and if it is determined that it was generated, the process proceeds to S11, and if it is determined that it was not generated, it notifies the controller 140 that the synthesis was completed without synthesizing the image data, and the process proceeds to S12. For example, in the case of print data 32 not including a special color designation command as shown in FIG. 3B, print data generated from the print target document as shown in FIG. 7(a) and print data for the watermark as shown in FIG. 7(b) are generated as image data not including a special color in S8, and therefore, special color image data is not generated.

S11: The image synthesizing part 150 which determined that special color image data was generated removes the special color image data from the special color print image storage part 210, adds it to the print image storage part 200, and notifies the controller 140 that the synthesis of the print images was completed.

For example, in the case of print data 43 including a special color designation command as shown in FIG. 4C, the image data for printing CMYK as shown in FIG. 6B and the special color image data for printing a special color of 41% density as shown in FIG. 6D are synthesized.

S12: The controller 140 that is notified that the completion of the synthesis instructs the image forming part 160 to print the print image data. The image forming part 160 which received the printing instruction reads the print image data stored in the print image storage part 200, performs the printing on a medium, and finishes the process. In this way, the image forming part 160 prints first image data (special color image data) in which the first color was changed and a second image data expressing the first color without the first color being changed (normal image data which is print image data of a color not including a special color) on the same medium. In the embodiment, the controller 140 determines that the image data of the watermark is with 41% density and the special color designation. Thereby, the image data of the watermark (or the object) is printed with the designated special color developer. The image data of the print target document is printed with normal color developers.

For example, in the case of print data 43 including a special color designation command as shown in FIG. 4C, an image shown in FIG. 6(e), in which the image data for printing CMYK as shown in FIG. 6(b) (normal image data) and image data of a special color (special color image data) for printing a special color of 41% density as shown in FIG. 6(d) are synthesized, is printed. On the other hand, in the case of print data 32 which does not include a special color designation command as shown in FIG. 3B, an image that does not have a special color image as shown in FIG. 7(d) is printed.

In this way, in this embodiment, in operating the printer driver when performing printing, a special color drawing can be designated more easily, and a special color image that does not depend on the drawing content of a document can be easily printed over data generated by a typical document generating application software for offices.

Further, since an image for special color designation and covering is color and grayscale data if a special color is not designated, by designating grayscale with the printer driver and executing test printing of a watermark or a form, the print image can be easily checked.

Furthermore, data for drawing with a special color can be used without special processing.

Further, in this embodiment, although an example, in which print image data which does not include a special color and special color print image data are simply put together for printing, was explained, by considering the thickness of a toner layer at the time of printing, etc., the layer thickness of both images may be adjusted at the time of synthesizing.

As explained above, in the first embodiment, an effect can be obtained, in which printing can be performed in which drawing by a special color developer is designated.

Further, since a special color designation was enabled for print data that can be added by a printer driver and a special color image was generated by performing a grayscale conversion on the printer side on print data in a range in which a special color was designated, an effect that a print function in which special color images are overlapped can be easily provided to a user, can be obtained.

Further, for a watermark, data that can be drawn is limited to a range in which it can be set on a setting screen of a printer driver, but it is possible to create form data from print data of the printer driver output and register it in a printer, so an effect that an arbitrary special color image can be added to print data can be obtained.

As discussed above, the printer 100 includes controller 140 and print image generation part 130. The print image generation part 130 further includes image generation part 131 and special color image generation part 132. In the image generation part 131, the normal image data of the target print document is generated, in which items of the document are each related to normal color developers. In section (a) of FIG. 6, texts relate to black, the circle relates to red, the rectangle shape item relates to blue, the triangle item relates to green. Full color image relates to all of the colors. Eventually, the normal image data is to be printed with the associated normal color developers. In the special color image generation part 132, other image data, which is of the object (or watermark), is generated. When the user has selected to print the object with a special color, the controller converts the special color image data into monochrome data with a predetermined density. Information indicating that the object is to be printed with a special color is attached to the image data (the information is special color information). These two image data are combined at image synthesizing part 150. As shown in section (e) of FIG. 6, the combined image data includes the items of the target print document and the monochrome object. When the combined image data is printed, the controller 140 prints the items of the print target document with corresponding normal color developers and the object with the special color developer based on the attached special color information.

### Embodiment 2

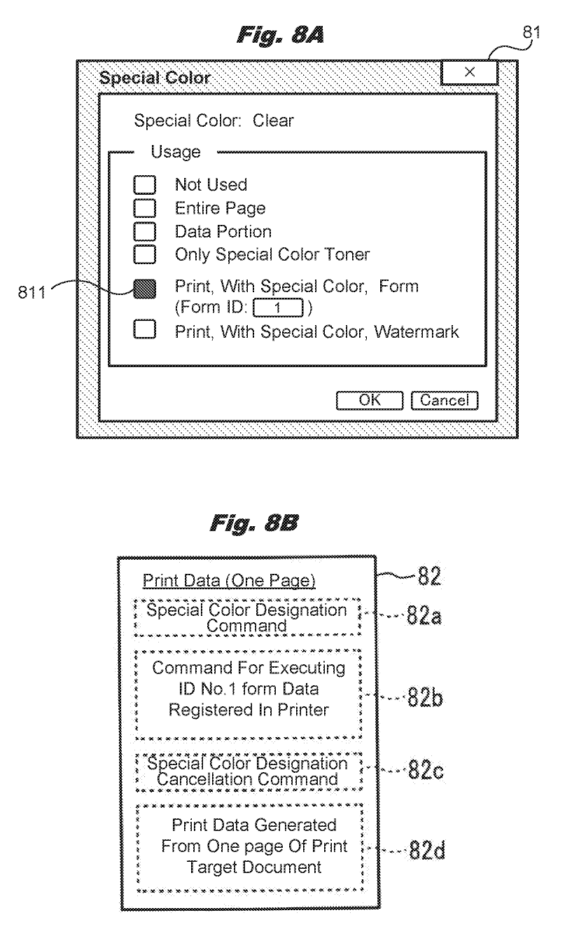

FIG. 9 is a block diagram showing a structure of an image forming system according to a second embodiment.

In FIG. 9, the image forming system 20 is constituted by a printer 300 as an image forming apparatus, a PC 400 as a higher-level device, and a communication line 403 for connecting the printer 300 and the PC 400 in a communicable manner.

In the PC 400, AP (application software) 401 and a printer driver (software) 402 as a print data generation device are installed, and the PC 400 sends print data to the printer 300 via the printer driver 402. The print data is generated by the AP 401 and includes normal print data (normal print data) which is print data such as words and drawings of a print target document and form data (special color image data) which is print data to be overlapped with the normal print data.

The printer 300, based on print data generated by the printer driver 402, forms images by a developer (color toner) of, e.g., a cyan color, a magenta color, a yellow color, a black color, a red color, a green color, a blue color, etc., and a special developer (special color toner) of, e.g., a white color, a transparent color, a gold color, a silver color, a paste, an adhesive agent, etc.

The printer 300 is equipped with a data receiving part 310, a receive buffer 311, a data judgment part 320, a form buffer 321, an edit part 330, a normal image generation part 331, a form image generation part 332, an image buffer 333, an engine controller 340, an engine part 350 constituted by an image forming part 351 and a fuser part 352, and a medium accommodation section 360.

The data receiving part 310 receives print data sent from the PC 400, stores it in the receive buffer 311, and notifies the completion of the receipt of the print data to the data judgment part 320.

The data judgment part 320 determines whether the print data stored in the receive buffer 311 is form data or normal print data, and when it is determined to be form data, its print data is stored in the form buffer 321, and when it is determined to be normal print data, the edit part 330 is notified with an instruction to start the editing of the print data.

The edit part 330, when notified of an instruction to start the editing of the print data from the data judgment part 320, reads the print data from the receive buffer 311 and the form buffer 321, and generates print image data using the normal image generation part 331 and the form image generation part 332.

The normal image generation part 331 performs generation of print image data using a processed color (may include a black color (K)) such as a cyan color (C), a magenta color (M), and a yellow color (Y) and stores the normal print data in the image buffer 333.

The form image generation part 332 performs the generation of print image data using a clear color (CL) such as a white color (W) and a transparent color, etc., which are special colors unique to the apparatus and stores the form print data in the image buffer 333.

The image buffer 333 is a memory part for recording print image data which uses a processed color such as CMY, etc., and print image data which uses a special color.

When the generation of the print image data by the edit part 330 is completed, the engine controller 340 reads print image data from the image buffer 333, and instructs the engine part 350 to print the print image data.

The engine part 350 is constituted by the image forming part 351 and the fuser part 352, and performs printing on a print medium.

The medium accommodation section 360 is for accommodating a print medium in which the engine part 350 performs the printing.

Further, the PC 400, the printer 300, the data receiving part 310, the data judgment part 320, the edit part 330, and the image forming part 351 of this embodiment respectively correspond to the PC 101, the printer 100, the data receiving part 110, the data analyzing part 120, the print image generation part 130, and the image forming part 160 as shown in FIG. 1.

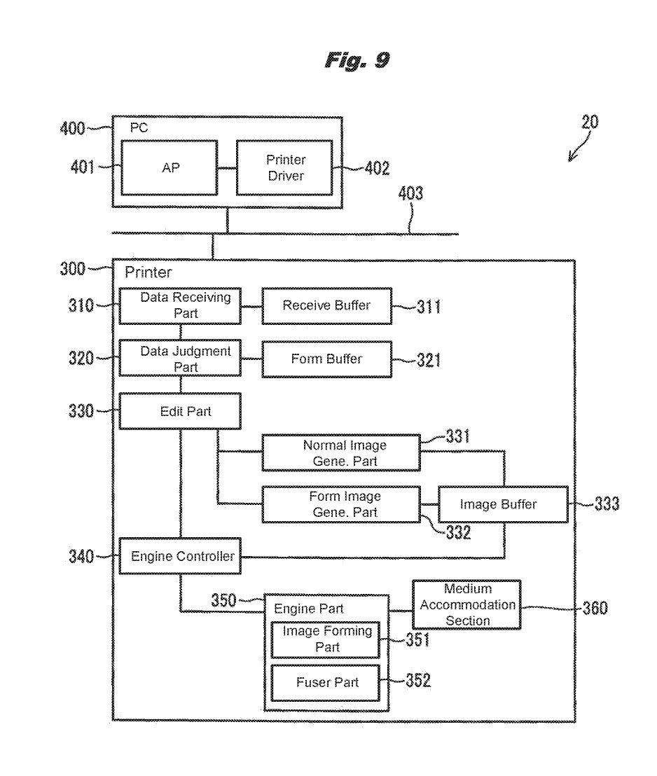

FIG. 10 is a schematic side view showing the structure of an image forming apparatus of the second embodiment.

In FIG. 10, a printer 300 is constituted by a panel section 194, image drums 180a, 181a, 182a, 183a, and 184a for forming and transferring a toner image as a developer image of each color of Y, M, C, W, CL (Y: yellow, M: magenta, C: cyan, W: white, CL: clear) on a medium, a fuser 185 (fuser part 352) for fusing a toner that is transferred on a medium with heat, a carrying belt 186 for carrying the medium in the medium carrying direction shown by the arrow A in the drawing, a tray unit 187 for storing the medium 188 (medium accommodation section 360), and a selector switch 190 for either ejecting the medium in which the toner is fused to outside of the apparatus via an ejection roller 193 or carrying it again to the image drums 180a, 181a, 182a, 183a, and 184a via sensors 191, 192, and 189.

In this embodiment, the image drums are arranged in the order of image drum (Y) 180a, image drum (M) 181a, image drum (C) 182a, image drum (W) 183a, and image drum (CL) 184a from an upstream side of the carrying direction of the medium.

The engine controller 340 shown in FIG. 9 controls each of the structures described above, transfers a normal color of an image drum (Y) 180a, an image drum (M) 181a, and an image drum (C) 182a onto a medium fed from the medium accommodation section 360, a special color of an image drum (W) 183a and an image drum (CL) 184a unique to the apparatus are transferred to fuse a toner image formed in the image forming part 351 based on the print image data with a fuser part 352, the medium is conveyed to outside of the apparatus to perform printing on the medium.

Further, the printer 300 is configured such that an image can be formed on the same medium by transferring and fusing the image on the same medium divided into a plurality of times.

The functions of the aforementioned structures will be explained.

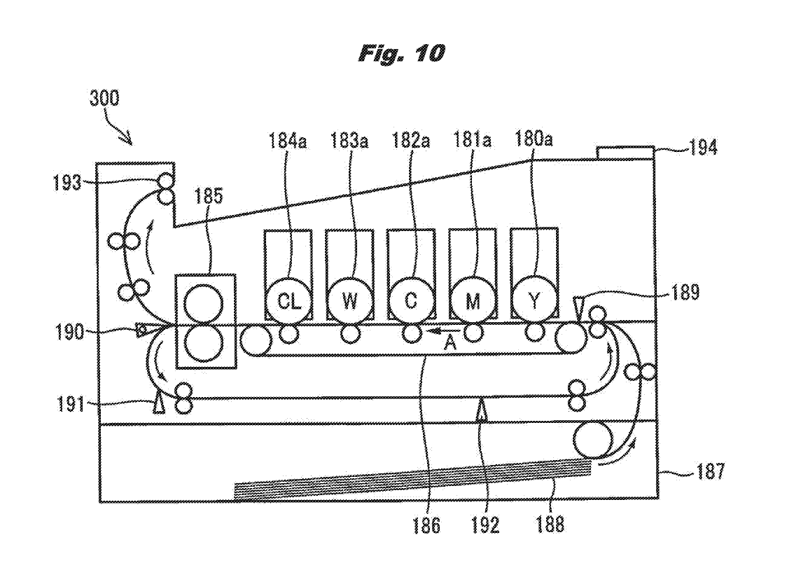

First, a print data creation process performed by the PC will be explained according to the steps shown by S in the drawing of the flowchart showing the flow of the print data creation process in the second embodiment of FIG. 11 with reference to FIG. 9.

S100: In a case in which print data is created using an AP 401 of a PC 400 and printing is performed by sending the print data to a printer 300 via a printer driver 402, the printer driver 402, in a similar manner as in the first embodiment, for example, performs a special color printing designation on the setting screen 42 as shown in FIG. 4, in which form data is printed in a special color.

Also, the printer driver 402 displays a screen for selecting whether or not to use form data registration to accept a selection operation by an operator. When a selection operation to use the form data registration is received, the process proceeds to S105, and when a selection operation to not use the form data registration is received, the process proceeds to S101.

S101: When the printer driver 402 receives a selection operation to not use the form data registration, the AP 401 creates normal data as normal image data.

S102: AP 401 which created normal print data performs the creation of form data as special color image data next.

S103: When the AP 401 creates normal print data and form data, first, the printer driver 402 sends the form data to the printer 300, and instructs the printer 300 to print the form data.

S104: The printer driver 402 which performed the sending of the form data sends the normal print data to the printer 300, and instructs the printer 300 to print the normal print data associated with the form data to finish this process.

S105: The printer driver 402 which received the selection operation to use the form data registration displays a screen for selecting whether to use form data that is already registered to the printer 300 or to newly register form data at the display section to receive a selection operation of an operator. When a selection operation to use the pre-registered form data is received, the process proceeds to S108, and when a selection operation to register new form data is received, the process proceeds to S106. Further, the printer driver 402, when it receives the selection operation to use the pre-registered form data, it receives an input such as a registration ID, a registration number, etc., as identifying information for identifying the form data to be used

S106: When the printer driver 402 newly receives a selection operation to use the form data registration, the AP 401 creates form data.

S107: The printer driver 402 sends the created printer driver 402 to the printer 300 and performs the registration of the form data. Further, at this time, a registration ID, a registration number, etc., as identification information for identifying the registered form data are applied by the printer 300.

S108: The AP 401 creates normal print data and form data, and the printer driver 402 sends the normal print data created by the AP 401 to the printer 300, and instructs the printer 300 to print the normal print data.

S109: The printer driver 402 designates identification information of form data, sends information for instructing the printing of the form data to the printer 300, and completes this process.

Further, in this embodiment, it is possible to use form data in which any color including a white color and a clear color is designated.

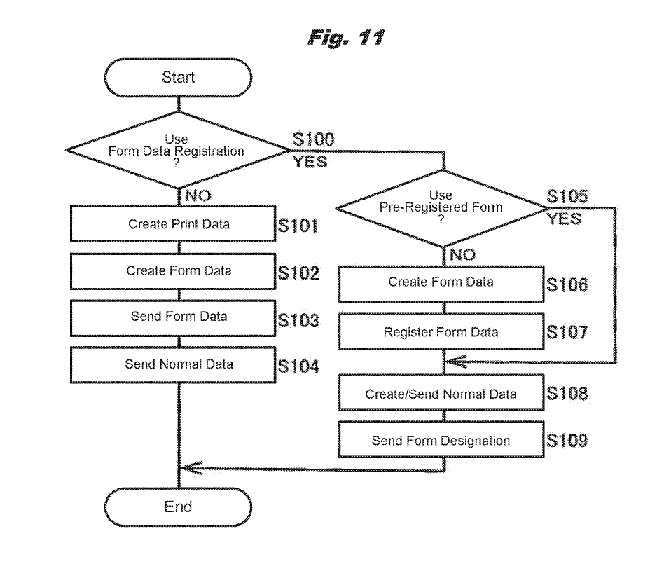

Next, print processing performed by the printer will be explained according to the steps S shown in the drawing of the flowchart showing the flow of the print processing according to the second embodiment of FIG. 12 with reference to FIG. 9.

S200: When print data is sent from a PC, the data receiving part 301 of a printer 300 receives the print data.

S201: The data receiving part 310 stores the received data in a receive buffer 311, and notifies the data judgment part 320 that the print data was received.

S202: The data judgment part 320 which received the notification that the print data was received judges whether the received print data is normal print data or form data, and when it is judged that it is normal print data, the process proceeds to S204, and when it is judged that it is form data, the process proceeds to S203.

S203: The data judgment part 320 which judges to be form data, stores the received print data in the form buffer 321 and completes this process.

S204: The data judgment part 320 which judged to be normal print data notifies the edit part 330 an instruction to start editing the normal print data, and the edit part 330 performs normal data edit processing for editing the normal print data.

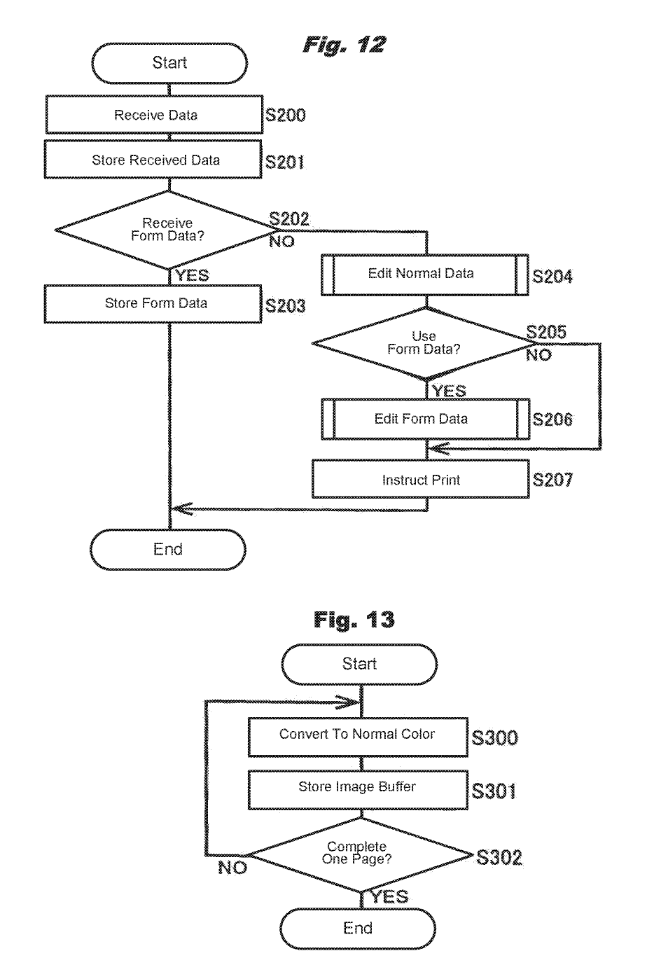

Here, the normal print data edit processing performed by the edit part 330 will be explained according to the steps S shown in the drawing of the flowchart showing the flow of the normal data edit processing according to the second embodiment of FIG. 13 with reference to FIG. 9.

S300: The edit part 330 creates print image data in which normal print data stored in the receive buffer 311 is converted (normal color conversion) into a processed color such as C, M, Y, (K) using the normal image generation part 331.

S301: The normal image generation part 331 stores the created print image data in the image buffer 333.

S302: The edit part 330 judges whether or not the creation of one page of print image data is completed, and when it is not completed, the process returns to S300 to continue the process, and when it is completed, this process is terminated.

Returning to the explanation of FIG. 12

S205: The edit part 330 which completed the edit processing of the normal print data judges whether or not to use form data, and when it judges to use it, the process proceeds to S206 and when it judges to not use it, the process proceeds to S207.

S206: The edit part 330 which judged to use the form data creates print image data in which the form data stored in the form buffer 321 is converted to a special color such as W (white) and CL (clear) unique to the apparatus using the form image generation part 332.

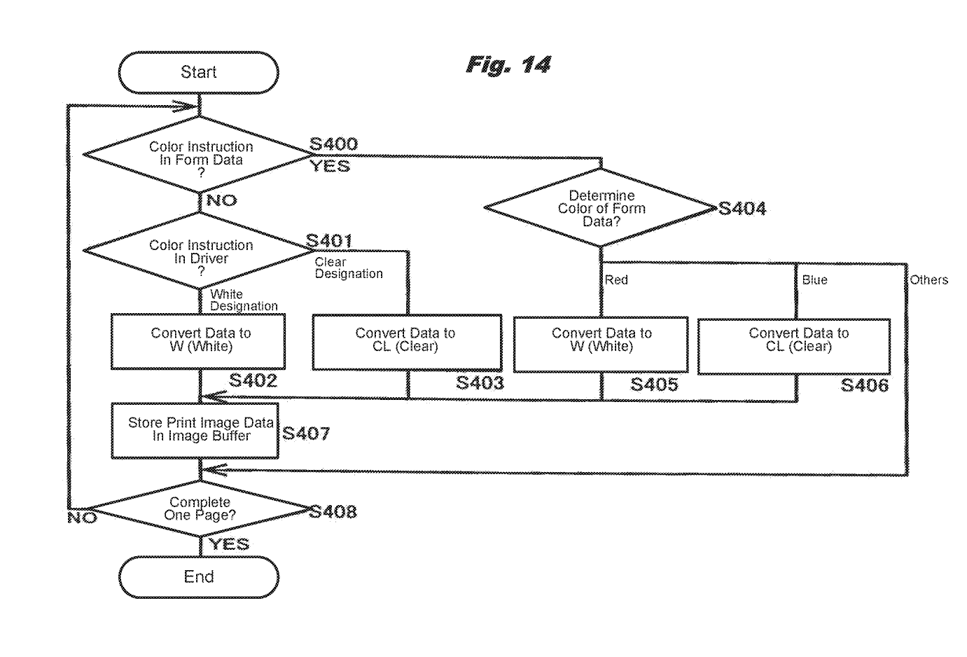

Here, the form data edit processing performed by the edit part 330 will be explained according to the steps S shown in the drawing of the flowchart showing the flow of the form data edit processing in the second embodiment of FIG. 14 with reference to FIG. 9.

S400: In accordance with the instruction of the edit part 330, the form image generation part 332 judges the presence or absence of an instruction of an output color of the form data, and when it is determined that an instruction for an output color exists, the process proceeds to S404, and when it is determined that the instruction for an output color is absent, the process proceeds to S401.

S401: The form image generation part 332 which judged that an instruction of an output color is absent in the form data judges the output color instructed by the printer driver 402, and when it judges that the instruction is for W (white), the process proceeds to S402, and when it is judged that the instruction is for CL (clear color), the process proceeds to S403.

S402: The form image generation part 332 which judged that the output color instructed by the printer driver 402 is instructed to be W (white) converts form data stored in the form buffer 321 into W (white), which is a special color unique to the apparatus to create print image data, and the process proceeds to S407.

S403: The form image generation part 332 which judged that the output color instructed by the printer driver 402 is instructed to be CL (clear) converts form data stored in the form buffer 321 into CL (clear), which is a special color unique to the apparatus to create print image data, and the process proceeds to S407.

S404: The form image generation part 332 which judged that there is an instruction for an output color in the form data judges the color of the form data stored in the form buffer 321, and when it is judged to be red, the process proceeds to S405, when it is judged to be blue, the process proceeds to S406, and when it is judged to be neither red or blue, it makes a change in which the form data stored in the form buffer 321 is reduced (cancelled, deleted, thinned, reduced density, etc.), and the process proceeds to S408 without generating a print image data.

In this way, the image generation part 332 changes a first color (red or blue) of first image data (special color image data) to a developer instructed for the type change (special color developer), and makes a change in which third image data (special color image data) of a second color (a color other than red or blue) that is different from the first color of the first image data (special color image data) is reduced.

S405: The form image generation part 332 which judged that the color of the form data is red converts form data stored in the form buffer 321 into W (white), which is a special color unique to the apparatus to create a print image data, and the process proceeds to S407.

S406: The form image generation part 332 which judged that the color of the form data is blue converts form data stored in the form buffer 321 into CL (clear), which is a special color unique to the apparatus to create a print image data, and the process proceeds to S407.

S407: The form image generation part 332 stores the generated print image data in the image buffer 333.

S408: The edit part 330 judges whether or not the creation of one page of print image data is completed, and when it is not completed, the process is returned to S400 to continue the process, and when it is completed, it instructs the engine controller 340 to print image data of the image buffer 333 and the process is terminated.

Returning to the explanation of FIG. 12,

S207: The engine controller 34 reads the print image data of the image buffer 333 using the engine part 350, performs printing on a medium accommodated in the medium accommodation section 360 and finishes the process.

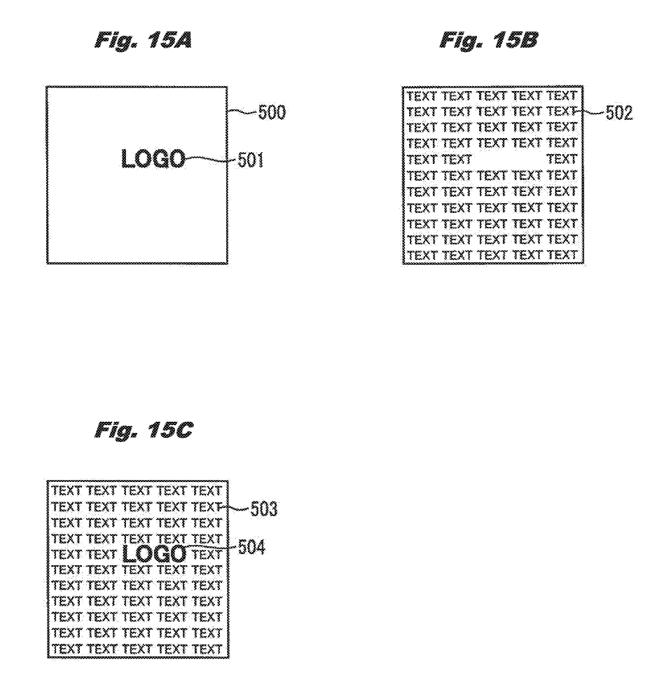

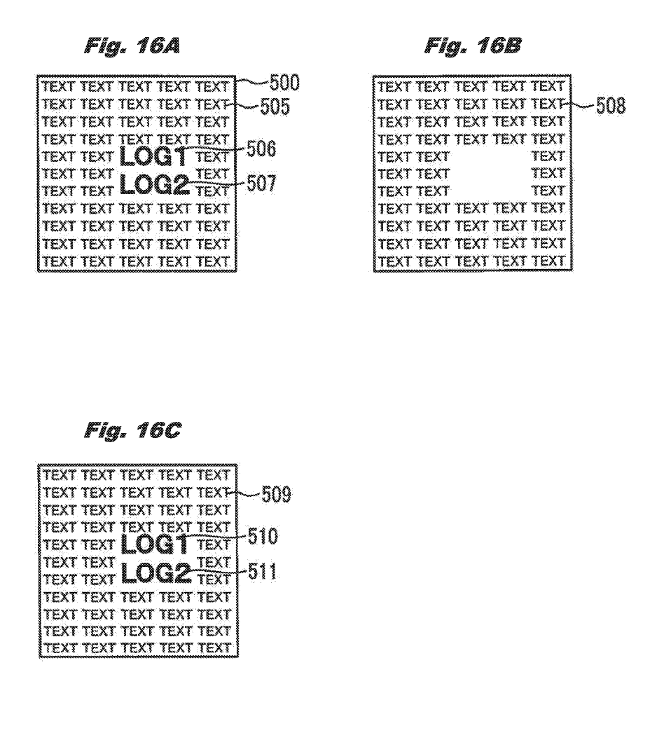

FIG. 15 and FIG. 16 are explanatory drawings of form data, normal data, and print result according to the second embodiment. FIGS. 15A and 16A show form data, FIGS. 15B and 16B show normal print data, and FIGS. 15C and 16C show form data and normal print data.

In FIG. 15, “500” in FIG. 15A denotes a size of a print medium, and “501” denotes form data for printing and outputting in a special color that is unique to the apparatus. Further, “502” in FIG. 15B denotes normal print data to be printed together with the form data 501. In FIG. 15C, “503” denotes a print output in which normal print data 502 is converted to a processed color such as C, M, Y, (K), etc., by the normal image generation part 331 shown in FIG. 9, and “504” denotes a print output which is converted to an special color unique to the apparatus by a form image generation part 332 shown in FIG. 9.

In FIG. 16, “506” in FIG. 16A is form data generated in red, expressing data which is converted to W (white) among special colors unique to the apparatus by a form image generation part 332 shown in FIG. 9. Further, 507 is form data generated in blue, expressing data which is converted to CL (clear color) among special colors unique to the apparatus by a form image generation part 332 shown in FIG. 9. Furthermore, “505” denotes form data generated in a color other than red or blue, expressing data which is cancelled by a form image generation part 332 shown in FIG. 9.

“508” in FIG. 16B denotes normal print data to be printed together with form data 506 and 507.

In FIG. 16C, “509” denotes a print output in which normal print data 508 is converted to a processed color such as C, M, Y, (K), etc., by the normal image generation part 331 shown in FIG. 9, “510” denotes a print output in which a form data 506 is converted to W (white) among the special colors unique to the apparatus by a form image generation part 332 shown in FIG. 9, and “511” denotes a print output in which a form data 507 is converted to CL (clear color) among the special colors unique to the apparatus by a form image generation part 332 shown in FIG. 9.

As explained above, in the second embodiment, an effect capable of performing printing of form data in which a drawing by a special color developer is designated, can be obtained.

Further, by separating form data and normal print data, converting the form data to a special color that is unique to the apparatus, and printing and outputting together with the normal print data, an effect can be obtained, in which form data can be printed at an arbitrary location in arbitrary data format for printing from an application software which cannot directly instruct for printing by a special color that is unique to the apparatus.

Furthermore, by creating data for normal print data and form data with different colors, it is possible to easily create form data printed and outputted in a special color that is unique to the apparatus while checking the print position of the original normal print data, and an effect in which a plurality of special colors can be used simultaneously.

In addition, in the first embodiment and the second embodiment, the image forming apparatus was explained as a printer, but it is not limited to them and can also be a multifunction printer (MFP).

What is claimed is:

1. An image forming method, comprising:
outputting print data that includes a first command, a second command, and first sub-print data for printing first image data, if a designation has been made to form the first image data by using a special color developer, the first sub-print data being arranged between the first command and the second command in the print data;
converting in gray color the first sub-print data for printing the first image that is arranged between the first command and the second command if the print data includes the first command; and
forming an image of the first image data on a medium by using the special color developer based on the first sub-print data that has been converted in the gray color.

2. The image forming method according to claim 1, wherein the first image data includes a first image formed with a first color that is different from a special color,
the method further comprising:
forming the first image data on the medium by using a second developer of the first color if the designation has not been made to form the first image data by using the first developer.

3. The image forming method according to claim 1, further comprising:
outputting the print data without applying the first command and the second command that sandwiches the sub-print data for printing the first image data if the designation has not been made to form the first image data by using the special color developer.

4. The image forming method according to claim 1, further comprising:
if a process of the print data has not ended, releasing the designation of the special color by using the second command after the sub-print data for printing the first image data has been converted into the gray color.

5. The image forming method according to claim 2, wherein
the first color developer is of at least one of cyan, magenta, yellow and black, and
the special color developer is a developer of a color other than the cyan, the magenta, the yellow and the black.

6. The image forming method according to claim 1, wherein
the first image data is image data for watermark, and
the method further comprising:
displaying a preview of the first image data in the first color that is different from the special color.

7. An image forming system, comprising:
an output part that is configured to output print data that includes a first command, a second command, and first sub-print data for printing first image data, if a designation has been made to form the first image data by using a special color developer, the first sub-print data being arranged between the first command and the second command in the print data;
a special color image generation part that is configured to convert in gray color the first sub-print data for printing the first image that is arranged between the first command and the second command if the print data includes the first command; and
an image forming part that forms an image of the first image data on a medium by using the special color developer based on the first sub-print data that has been converted in the gray color.

8. The image forming system according to claim 7, wherein the first image data includes a first image formed with a first color that is different from a special color, and
the image forming part forms the first image data on the medium by using a first color developer that is different from the special color if the designation has not been made to form the first image data by using the first developer.

9. The image forming system according to claim 7, wherein the output part is configured to output the print data without applying the first command and the second command that sandwiches the sub-print data for printing the first image data if the designation has not been made to form the first image data by using the special color developer.

10. The image forming system according to claim 7, further comprising:
a control part that is configured to control the image formation by the image forming part, wherein
the control part releases the designation of the special color by using the second command after the sub-print data for printing the first image data has been converted into the gray color if a process of the print data has not ended.

11. The image forming system according to claim 8, wherein
the first color developer is of at least one of cyan, magenta, yellow and black, and
the special color developer is a developer of a color other than the cyan, the magenta, the yellow and the black.

12. The image forming system according to claim 7, wherein the first image data is image data for watermark.

13. An image forming apparatus for forming an image, comprising:
a receive part that is configured to receive print data,
a special color image generation part that is configured to convert in gray color first sub-print data for printing a first image that is arranged between a first command and a second command if the print data received by the receive part includes the first command; and
an image forming part that forms an image of the first image data on a medium by using the special color developer based on the first sub-print data that has been converted in the gray color.

14. The image forming apparatus according to claim 13, wherein the image forming part forms the first image data on the medium by using a first color developer that is different form the special color if the first command and the second command are not included before and after the first sub-print data for printing the first image.

15. The image forming apparatus according to claim 14, wherein
the first color developer is of at least one of cyan, magenta, yellow and black, and
the special color developer is a developer of a color other than the cyan, the magenta, the yellow and the black.

16. The image forming apparatus according to claim 13, wherein the first image data is image data for watermark.

17. The image forming apparatus according to claim 13, wherein the first image data is information that indicates form data stored in a memory part.

18. The image forming apparatus according to claim 13, wherein
the memory part stores a plurality of form data, and
the image is formed based on form data among the plurality of form data that corresponds to the image data.
